(19) United States
(12) Patent Application Publication
(10) Pub. No.: US 2024/0402997 A1
(43) Pub. Date: Dec. 5, 2024

(54) SAMPLING OF RANDOM NUMBERS FROM ARBITRARY DISTRIBUTIONS

(71) Applicant: National Technology & Engineering Solutions of Sandia, LLC, Albuquerque, NM (US)

(72) Inventors: James Bradley Aimone, Keller, TX (US); John Darby Smith, Albuquerque, NM (US); Shashank Misra, Albuquerque, NM (US)

(21) Appl. No.: 18/204,991

(22) Filed: Jun. 2, 2023

(51) Int. Cl. G06F 7/58

(52) U.S. Cl. CPC G06F 7/588

(57) ABSTRACT

A method for probabilistic computing is provided. The method comprises specifying a target distribution for a computational model, wherein the target distribution is defined by a function. A number of coin flips are performed with a number of weighted coinflip devices, wherein weights for the coinflip devices are determined by the function. The number of coinflips are then converted to a random number from the target distribution according to outputs of the weighted coinflip devices, wherein a circuit uses the coin flips as inputs to randomly activate bits in a binary representation of the random number.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to probabilistic computing and to systems and methods for sampling true random numbers using stochastic devices.

### 2. Background

The increased adoption of AI/ML for multiple applications and increasing demand for more computation has led to higher demand for heterogeneous computing platforms that combine multiple technologies (GPUs, CPUs, etc.). And as more processors are incorporated, unused processors need to be turned off to deal with heat dissipation (i.e., ‘dark silicon’). These issues, coupled with a plethora of novel and emerging devices, in-memory computing, efficient chip-to-chip communication, 3D stacking, and integration techniques demand effective optimization across multiple scales. Nevertheless, there is a growing appreciation that not only is it increasingly expensive to enforce deterministic behavior in conventional microelectronics and computing technologies, but that it may be unnecessary to do so for applications in which incorporating stochastic behavior could prove to be beneficial. Accordingly, in recent years, more inherently probabilistic approaches to computing have begun to receive increased attention as an alternative to deterministic computing.

Random numbers are typically produced using pseudo-random number generators (PRNGs). PRNGs are deterministic algorithms that produce a sequence of bits following an initial value (the “seed”), which both conform to the distribution of interest and arrive in a sufficiently random order. Statistical measures that compare differences in distribution, like entropy, and rigorous random tests like those in the NIST (National Institute of Standards and Technology) package provide the means of testing PRNGs. Such algorithms satisfying these types of tests can be efficiently computed on hardware that is already optimized for serial arithmetic. Although the statistical implications of this determinism require care in the development of complex applications to ensure validity, PRNGs are used both due to their ease of generation and their utility in verification of codes, whereby a set seed will provide repeated behavior.

However, applications that have stringent demands on the quality of random numbers, such as cryptography, often push the limit of today's PRNGs. Furthermore, the serial operation of PRNGs introduces complexities in highly parallel architectures which may need to generate a high quantity of random numbers in parallel. Finally, PRNGs typically produce random numbers from a uniform distribution, requiring additional computation to convert a sample to the type of random distribution required.

Therefore, it would be desirable to have a method and apparatus that take into account at least some of the issues discussed above, as well as other possible issues.

### SUMMARY

An illustrative embodiment provides a method for probabilistic computing. The method comprises specifying a target distribution for a computational model, wherein the target distribution is defined by a function. A number of coin flips is performed with a number of weighted coinflip devices, wherein weights for the coinflip devices are determined by the function. The number of coinflips are then converted to a random number from the target distribution according to outputs of the weighted coinflip devices, wherein a circuit uses the coin flips as inputs to randomly activate bits in a binary representation of the random number.

Another illustrative embodiment provides a system for probabilistic computing. The system comprises a storage device that stores program instructions and one or more processors operably connected to the storage device and configured to execute the program instructions to cause the system to: specify a target distribution for a computational model, wherein the target distribution is defined by a function; perform a number of coin flips with a number of weighted coinflip devices, wherein weights for the coinflip devices are determined by the function; and convert the number of coinflips to a random number from the target distribution according to outputs of the weighted coinflip devices, wherein a circuit uses the coin flips as inputs to randomly activate bits in a binary representation of the random number.

Another illustrative embodiment provides a computer program product for probabilistic computing. The computer program product comprises a computer-readable storage medium having program instructions embodied thereon to perform the steps of: specifying a target distribution for a computational model, wherein the target distribution is defined by a function; performing a number of coin flips with a number of weighted coinflip devices, wherein weights for the coinflip devices are determined by the function; and converting the number of coinflips to a random number from the target distribution according to outputs of the weighted coinflip devices, wherein a circuit uses the coin flips as inputs to randomly activate bits in a binary representation of the random number.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a true random number generator in accordance with an illustrative embodiment;

FIG. 2 depicts a depicted illustrating rejection sampling for drawing random numbers in accordance with the prior art;

FIG. 3 depicts a diagram illustrating the integration of true random number generators into a neuromorphic architecture in accordance with an illustrative embodiment;

FIG. 4 depicts a diagram of a stochastic magnetic tunnel junction in accordance with an illustrative embodiment;

FIG. 5 depicts a depicts a diagram of a stochastic tunnel diode in accordance with an illustrative embodiment;

FIG. 6 depicts a diagram illustrating a process for drawing model-specific random numbers from hardware in accordance with an illustrative embodiment;

FIG. 7 depicts a diagram illustrating a process of random sampling with stochastic coinflip devices in accordance with an illustrative embodiment;

FIG. 8 depicts a diagram illustrating a process of random sampling with pre-tuned coinflip devices in accordance with an illustrative embodiment;

FIG. 9 depicts a diagram illustrating a process of random sampling with a neural network and pre-tuned coinflip devices in accordance with an illustrative embodiment;

FIG. 10 depicts a flowchart illustrating a process for probabilistic computing in accordance with illustrative embodiments; and

FIG. 11 is a diagram of a data processing system depicted in accordance with an illustrative embodiment.

### DETAILED DESCRIPTION

The illustrative embodiments recognize and take into account one or more different considerations. For example, random numbers are typically produced using pseudo-random number generators (PRNGs). PRNGs are deterministic algorithms that produce a sequence of bits following an initial value (the “seed”), which both conform to the distribution of interest and arrive in a sufficiently random order.

The illustrative embodiments also recognize and take into account that applications that have stringent demands on the quality of random numbers, such as cryptography, often push the limit of today's PRNGs. Furthermore, the serial operation of PRNGs introduces complexities in highly parallel architectures which may need to generate a high quantity of random numbers in parallel.

The illustrative embodiments also recognize and take into account that there are many numerical techniques for generating random numbers, most of which are based on generating a random number sampled from a uniform distribution from some range (such as a random integer between 0 and 255). Many numerical tasks require a random number sampled from a more complex distribution. Depending on the distribution there are direct arithmetic methods or numerical methods (e.g., rejection sampling) for converting uniform random numbers to samples from the desired distribution.

The illustrative embodiments also recognize and take into account that PRNGs typically produce random numbers from a uniform distribution, requiring additional computation to convert a sample to the type of random distribution required.

The illustrative embodiments provide a method and system for probabilistic computing in which large numbers of randomly tuned devices such as magnetic tunnel junctions and tunnel diodes operate in a stochastic regime and are incorporated into a scalable neuromorphic architecture. Using the devices to perform coinflips, the illustrative embodiments directly generate random numbers from a user-defined probability distribution.

Many complex computational problems, such as modeling nuclear and high-energy physics events, understanding complex biological systems, simulating more precise climate models, optimization, and implementing more effective artificial intelligence (AI), require simulating probabilistic behaviors on existing deterministic hardware. Probabilistic computing comprises any computing process that calculates or approximates solutions to a model or task (or distributions of solutions) through random sampling or probabilistic manipulation. Probabilistic approaches are widely used when a problem is best modeled as a stochastic system, such as in quantum mechanics, but can also be used in lieu of complex deterministic models by sampling a different, ideally simpler, model. The software use of probabilistic methods on deterministic hardware has long been a major emphasis of the numerical methods community.

In sampling tasks, the speed and efficiency of random number generators (RNGs) and their subsequent transformations often contribute to computational complexity. The availability of hardware that makes probabilistic computing more efficient creates an opportunity for these techniques to extend to application areas that have not traditionally been thought of as probabilistic in nature.

Despite their widespread use, there are limitations of PRNGs that make a hardware alternative to PRNGs, or a “true” random number generator (tRNG) appealing. First, applications that have stringent demands on the quality of random numbers, such as cryptography, often push the limit of today's PRNGs. Second, the serial operation of PRNGs introduces complexities in highly parallel architectures which may need to generate a high quantity of random numbers in parallel. Finally, PRNGs typically produce random numbers from a uniform distribution, requiring additional computation to convert a sample to the type of random distribution required. To date, most tRNGs have focused primarily on this last quality consideration, with tRNG circuits that are highly effective for cryptography applications but may not scale to large-scale numerical tasks.

One example of a system that leverages probabilistic computing at large-scale is the human brain, a complex system with 10¹⁵ synaptic connections between 10¹¹ neural cells. The release of neurotransmitters at synapses is a probabilistic process on the order of one release of neurotransmitter per second per synapse. Despite its ubiquity, the brain's stochasticity remains an underexplored area of neuroscience. What is known is that the brain's stochasticity is tightly regulated within each region's specific neuron populations and there is a growing appreciation of the computational implications of this widespread stochasticity. Furthermore, the brain's apparent randomness is not limited to the synapse scale, but appears at other spatial scales as well, such as the reconfiguration of neural circuit architectures over time, and probabilistic models are effective at explaining observations of large-scale recordings of neural populations.

Considering the brain's degree of randomness as a notional goal for a probabilistic computing system, it is worth noting how far today's deterministic microelectronics are from achieving that magnitude. Using today's conventional systems, the generation of 10¹⁵ random numbers per second (RN/s) would require nearly 1000 CPUs and 150 kW using software based PRNGs. Circuit based tRNGs, such as ring oscillators, may improve energy efficiency, but would require over 100,000 circuits and leave unsolved the communication of outputs to the computational logic. The illustrative embodiments recognize that a computational system with a brain-like stochastic capability of producing 10¹⁵ RN/s represents a fundamentally new computational opportunity. To accomplish this goal of ubiquitous stochasticity several implications must be addressed.

First, achieving the targeted scale of tRNGs requires adapting devices and circuits to the physics of materials, rather than the other way around. The continued scaling of transistors has enabled attaining high resource requirements for useful contemporary computations. However, for stochastic computing a similar scaling opportunity may not exist. Meeting this challenge requires consideration of novel device types and materials, such that useful random number generation can be accomplished by a handful of nanoscale devices with a size and power footprint comparable to modern transistors. This tailoring of devices and circuits to leverage non-trivial behaviors at the physics and materials scales will enable dramatic efficiency gains.

Second, device-level randomness must be transformed to useful statistical samples without resorting to time-consuming calculations. Meeting this challenge requires multiscale codesign for the algorithms to leverage the underlying physics of the devices. Furthermore, leveraging the stochasticity of individual devices produces simple stochastic variables, such as a Bernoulli “coinflip,” rather than a more complex random variable. Complexity can then be built up from there.

Third is the question of using these random numbers and integrating them into numerical computations. Producing a billion random numbers is of little value to simply use them serially in a conventional von Neumann manner. Neuromorphic architectures provide a path to use stochastic resources in parallel, as well as a framework to consider novel materials and devices.

Finally, there is the question of how to build and program such a probabilistic computer. This is not simply an architectural question, but also a device and circuits question, and one for which we propose will rely on increasingly more sophisticated AI design tools in the future.

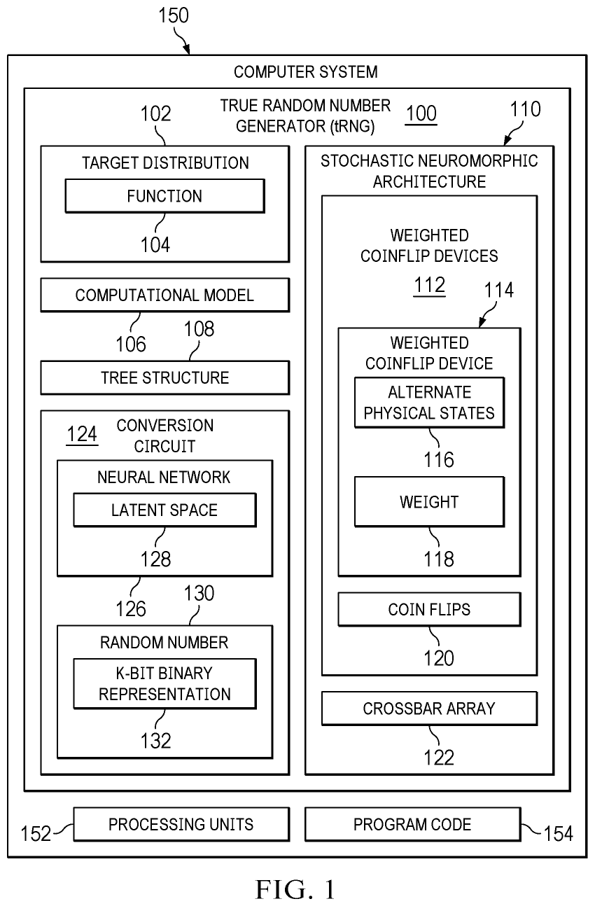

FIG. 1 depicts a block diagram of a true random number generator (tRNG) in accordance with an illustrative embodiment. tRNG 100 employs a number of weight coinflip devices 112 to sample a random number 130 from a target distribution 102 that is specified for a computational model 106. This target distribution 102 may be defined by a function 104 such as, e.g., a probability density function (PDF), probability mass function (PMF), cumulative distribution function (CDF), or characteristic function (CF).

The weighted coinflip devices 112 comprise stochastic devices such as, e.g., magnetic tunnel junctions, tunnel diodes, or CMOS transistors. Each weighted coinflip device 114 comprises alternate physical states 116 that can be represented as 0 or 1. Each weighted coinflip device 114 also comprises a respective weight (tuned probability) 118 of being in either of the alternate physical states 116. Weights 118 for the coinflip devices are determined by the function 104. The weighted coinflip devices 112 may be implemented in stochastic neuromorphic architecture 110 that comprises a crossbar array 122. The coinflip devices 112 may be located at intersections of the crossbar array 122 and operate as random access numbers.

The weighted coinflip devices 112 generate a number of coin flips 120. The coinflips may be generated by the weighted coinflip devices 112 according to a binomial expansion represented by a tree structure 108. Tree structure 108 may be, for example, a binary tree. However, tree structure 108 does not have to be binary. For example, target distribution 102 can be sampled with two set of two coinflip devices 112, wherein each coinflip device is independent and has a different weight (probability). If one of the sets of coinflip devices is randomly chosen, but the output viewed as the output of two coinflip devices, the output of those two coinflip devices will be correlated and can help sample from the desired target distribution 102. The coin flips can be written as tree structure that is not binary; a first coinflip determines which two coins to flip on the next level.

A conversion circuit 124 converts the coinflips 120 to random number 130, which may be in the form of a k-bit binary representation 132. Conversion circuit 124 may comprise a neural network that maps the coinflips 120 to a latent space 128 that is then mapped to the random number 130.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 150 is a physical hardware system and includes one or more data processing systems. When more than one data processing system is present in computer system 150, those data processing systems are in communication with each other using a communications medium. The communications medium can be a network. The data processing systems can be selected from at least one of a computer, a server computer, a tablet computer, or some other suitable data processing system.

As depicted, computer system 150 includes a number of processor units 152 that are capable of executing program code 154 implementing processes in the illustrative examples. As used herein a processor unit in the number of processor units 152 is a hardware device and is comprised of hardware circuits such as those on an integrated circuit that respond and process instructions and program code that operate a computer. When a number of processor units 152 execute program code 154 for a process, the number of processor units 152 is one or more processor units that can be on the same computer or on different computers. In other words, the process can be distributed between processor units on the same or different computers in a computer system. Further, the number of processor units 152 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

In the use case of a modeling and simulation (Mod-Sim) environment where a bigger computational task (presumably using conventional computer hardware) is being performed, the task requires a sample of a random number from some physics-defined distribution. For example, a Monte Carlo task may require a random number drawn from an exponential distribution with some parameterization and range. The user, of course, does not care where the random number comes from but does have requirements on how a series of those random numbers drawn from the same distribution will be distributed. In principle, the end-use case will ask for independent, identically distributed (i.i.d.) random numbers.

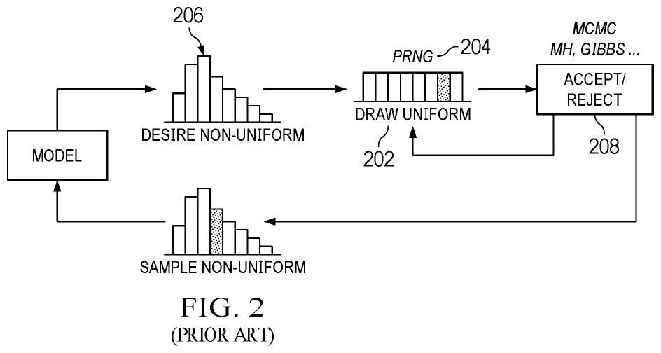

FIG. 2 depicts a depicted illustrating rejection sampling for drawing random numbers in accordance with the prior art. Currently, the user generally has two options, both starting with a uniform random number 202 generated using a PRNG 204. The first option, which is generally the most efficient, is to analytically transform the uniform random number to a number belonging to the target distribution 206. This transformation requires knowing the inverse of the cumulative density function (CDF) of the target distribution, which in some cases is well known but in other cases is non-trivial to compute, impossible to define analytically, or suffers from numerical stability issues. The second option is to use some form of rejection sampling 208, which comprises drawing a random number 202 from a simpler distribution (such as uniform or a transformed uniform random number) and then draw a second random number to determine whether to keep the value of the first random number according to the probability density function (PDF) that a random number would come from that bin. Pure rejection sampling has nice guarantees associated with it, but it can be computationally very expensive. Therefore, there are a range of approaches to improve upon it that target improved efficiency with other trade-offs. Some of these approaches, such as Metropolis-Hastings sampling and Gibbs sampling, are extensively used in higher dimensional applications and, while computationally expensive themselves, are necessary for complex sampling applications.

Stepping back from the context described above, the user requirement is an i.i.d. random number sample from some user-defined distribution, and the mechanism to obtain it is irrelevant. The illustrative embodiments compute this random number directly from a set of hardware true random number generators (tRNGs) and directly produce a desired sample drawn from the desired PDF. What would these TRNGs be?One option are devices that can exhibit inherently stochastic behavior if operated under a certain voltage regime.

The circuits and architectures serve as a necessary intermediary between the hardware/devices and theory/algorithms, however this area of research is largely underserved because the circuits and architecture, by nature, cannot be readily altered in isolation. At present, arithmetic logic circuits and processing unit architectures have been long-established for a deterministic framework, and they are unlikely to be altered without radical changes first occurring in the hardware and theoretical fronts. Moreover, most current algorithms, particularly those used in AI, have been optimized for use in what are primarily deterministic architectures with PRNGs used to inject artificial stochasticity at the application level. For example, although the programmatic advantages of using PRNGs are considerable, the benefit of specialized parallel architectures for probabilistic algorithms will likely always be limited if they have to rely on an embedded PRNG, since most PRNGs are ultimately software generated. In other words, the “Von Neumann Bottleneck” between processing and memory (which limits the efficiency of software) is also a random number bottleneck. Just as simply using a faster tRNG in lieu of a PRNG will have a limited upside because the overall computation will still be serial, maintaining a reliance on PRNGs in an otherwise parallel architecture will simply make the generation of random numbers a bottleneck.

The term coinflip device refers to a device which produces a binary “heads-tails” output, and either takes an analog input that corresponds to biasing the coinflip or takes no input and produces a coinflip with a fixed probability. To enable probabilistic computing, the coinflip device must facilitate multiscale codesign at the other levels. Integration of coinflip devices alongside conventional logic is used to realize architectures that circumvent the von Neumann bottleneck. This kind of fine-grained integration requires more than just process and materials compatibility—an analog signal may need to be provided to the input to the coinflip device, and the output signal from the coinflip device may need to be boosted to digital logic levels. Additional circuitry will also be needed to move from the intermediate representations the coinflip devices efficiently generate to stochasticity that is ultimately useful, whether it involves analog neurons in a neuromorphic circuit or digital circuits to sample useful distributions. All this functionality should be accomplished using the area and power footprint of <100 transistors per coinflip device in order to keep the overall footprint to <1 mm² and the power to <10 W. Fortunately, coinflip devices which produce two distinct output signals denoting heads and tails can often be boosted to digital logic levels using only a handful of transistors. Thus, provided an appropriate source of randomness at the device level, the bulk of the size, power, and speed considerations can be focused on turning that source of randomness into sampling an application-specific distribution function. Importantly, there is a significant opportunity in understanding resource tradeoffs related to statistical accuracy and precision of the samples the devices are used to generate.

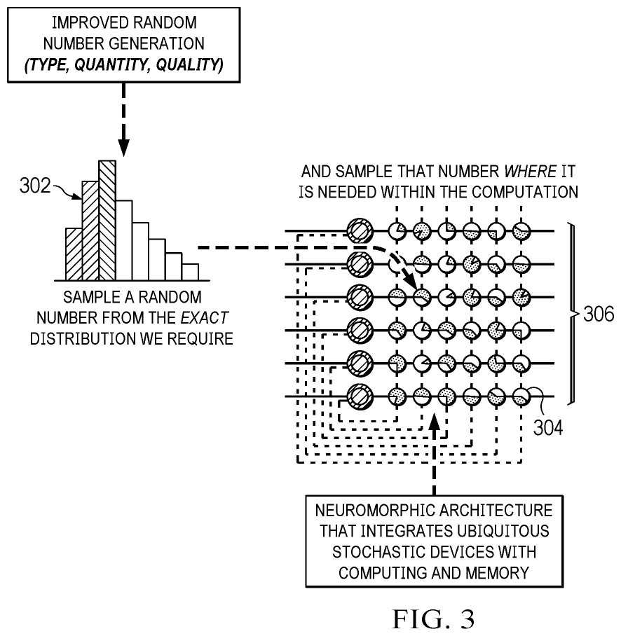

FIG. 3 depicts a diagram illustrating the integration of tRNGs into a neuromorphic architecture in accordance with an illustrative embodiment. The configuration depicted in FIG. 3 improves random number generation in terms of type, quantity, and quality. In this particular example, the tRNGs comprise a number of stochastic devices 304 that are incorporated into a crossbar array 306 such as a memory. A random number is sampled from the exact required distribution 302. That number is sampled where it is needed within the computation in the crossbar array 306.

The randomness that underlies probabilistic computing ultimately originates with fluctuations at the material level, while the other layers of abstraction transform and leverage this randomness. There is an important dichotomy between useful fluctuations that can be controlled on one hand and undesirable fluctuations on the other. The latter type may result in two nominally identical devices producing different statistics, or the same device producing inconsistent statistics over time. Before considering material properties that may amplify desirable fluctuations or suppress undesirable ones, it is important to recognize that fluctuations commonly originate from three basic physical phenomena—quantum superposition, number fluctuations, and thermal (or quantum) fluctuations. However, as we are specifically considering the opportunities offered by weighting and readout of simple coinflips at large scales, it is unlikely that quantum superposition can be a useful source of fluctuations in the foreseeable future because of the significant limitations associated with the extreme environmental requirements for most quantum systems.

In practice, myriad sources of both number fluctuations and thermal fluctuations are active in any material system and will play the roles of heroes and villains in probabilistic computing. Any average phenomena having a discrete basis—whether it is current being carried by discrete electrons, or the number of atoms in a 1 nm-thick oxide—will be subject to number fluctuations. To have a large fluctuation on a small background signal requires the total expected number of elements per unit time or length to be small. Unfortunately, most devices that produce or count single photons, electrons, etc., are energy inefficient. Thermal fluctuations from finite temperature are the other major source of stochasticity in a material. For continuous degrees of freedom, these fluctuations tend to be small compared to a large background signal and will likely require too much signal conditioning to be efficient. In general, good coinflip devices will rely on thermal fluctuations in systems with discrete degrees of freedom.

A typical two-level system has activated kinetics back and forth over an energy barrier and can be used in two different ways to generate a coinflip. In the first, the system has a shallow enough barrier between the two states that thermal excitation over the barrier leads to fast transitions from one state to the other and vice versa. In this case, tuning the device to a weighted coinflip is accomplished by making one of the potential wells deeper than the other.

In the second method, the system has well-defined states with a tall barrier. The system is brought to the unstable point between the two states and released, whence thermal fluctuations will tilt the system towards one state or another. Tuning the weighting of the device is accomplished by releasing the device slightly to the left or right of the unstable point between the two wells. In a variation of this mode of operation, the potential well itself is distorted so to have a single minimum at this location, which can be used to initialize the starting position of the particle when the barrier is re-established.

Two concrete examples of materials and devices which are promising for generating weighted coinflips are magnetic tunnel junctions (MTJ) and tunnel diodes (TD).

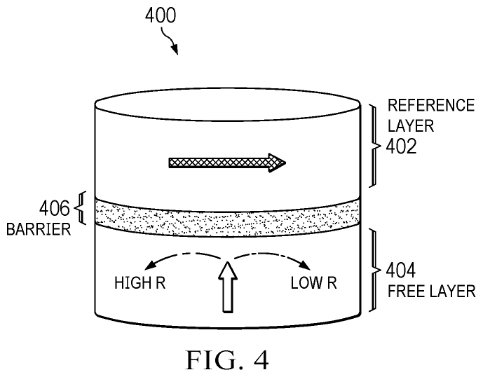

FIG. 4 depicts a diagram of a stochastic magnetic tunnel junction in accordance with an illustrative embodiment. MTJ 400 is a tunneling device comprising two thin magnetic metal electrodes 402, 404 separated by a thin insulating tunnel barrier 406. MTJ 400 can be readily integrated into back-end-of-line complementary metal-oxide semiconductor (CMOS) manufacturing. MTJ 400 is in the form of a nanopillar with a diameter less than about 50 nm with one electrode 402 with fixed magnetic moment and the other electrode 404 with a magnetic moment that is free to reorient. The tunneling resistance depends on the relative alignment of the magnetic moments of the electrodes 402, 404. Anti-alignment produces a high resistance state and parallel alignment produces a low resistance state, with a resistance change of a factor or 2 or 3 commonly realized.

MTJ 400 can also be thought of in terms of a double-well potential, with the x-axis being the magnetization of the free layer electrode 404. In one mode of operation thermal energy can switch the orientation of the free layer electrode 404, an effect known as superparamagnetism, producing two-level resistance fluctuations in the MTJ 400. In a second mode of operation, applied current pulses are used to initialize the free layer electrode 404 into a known unstable magnetic state, which is read out after letting the device relaxes into one of the two stable states.

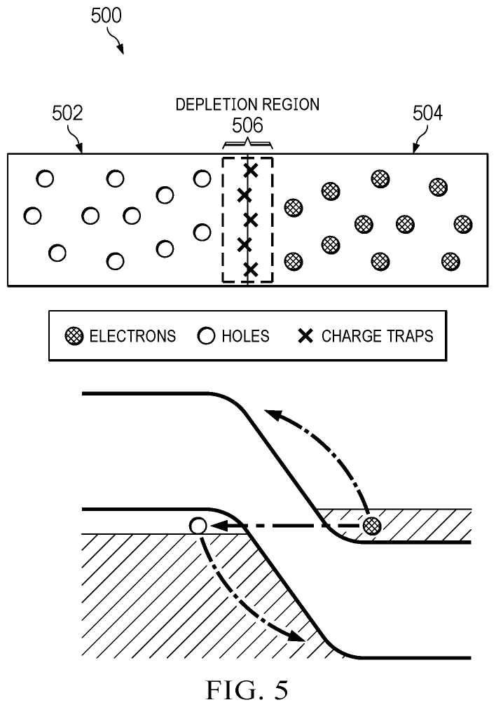

FIG. 5 depicts a depicts a diagram of a stochastic tunnel diode in accordance with an illustrative embodiment. Tunnel diode (TD) 500 comprises a strongly p-type doped region 502 and n-type doped region 504 in a semiconductor, wherein the resulting depletion region 506 between them is very narrow. While large discrete TDs have historically been used in analog high-speed electronics, the illustrative embodiments may employ nanoscale TDs integrated into front-end-of-line CMOS manufacturing for probabilistic computing. TD 500 can conduct the same amount of current either through tunneling or thermionic emission. Which branch the device takes depends on detailed charge occupancy of the defects in the junction and is detected by the TD 500 as a low (tunneling) or high (thermionic emission) voltage.

Conceptually, it is easiest to think of the TD in terms of a double-well potential where the x-axis is the charge occupancy of a single defect. Tuning this device is accomplished with a current pulse that gives the defect an average charge occupancy corresponding to the weight of the coinflip.

Devices such as MTJs and TDs will switch randomly between two states (referred to as “heads” and “tails”, which by convention equal “1” and “0”, respectively). The switching between states (“H->T” or “T->H”) can be viewed as a Poisson process; at any given instant (however defined), there is some probability that the device may switch states. If the probability of going from heads to tails is equal to that of going from tails to heads, the switching can be considered balanced. However, if, for whatever reason, the probability of going from H->T is different from T->H, the switching will be unbalanced, and the device will more likely be in one state than the other.

Over longer time scales, one can view a sample of the state of any one of these devices as a Bernoulli process (b=1 with some probability p(b)). A Bernoulli process is akin to a coinflip, generating a “heads” with a certain probability. The “fair” coinflip has a probability of 0.5, and an “unfair” coin would make one or the other outcome more likely. Ultimately, the ratio of the probabilities (P(H->T) and P(T->H)) will determine the Bernoulli probability of the device, and the ability to control these will directly relate to the precision and reliability of the device's random sample.

Due to the physics of these devices, it is possible, depending on the materials and the length and time scales, that devices can be correlated with one another. Similarly, it is possible that two samples from the same device will exhibit correlations depending on the time difference. The algorithms of the illustrative embodiments are able to make use these correlations, though the exact details of how the correlations operate are key to their utility.

The illustrative embodiments employ an algorithm that converts N coinflip devices to a random number, X, that is represented as a k-bit binary number. This method combines binomial expansions with some observations from neuromorphic models of generating random numbers. The algorithm approach uses the coinflips to randomly activate bits of the target random number's binary representation. As a result, the probability that the sampled binary number is observed matches the PDF's associated probability of the associated bin represented by the binary number.

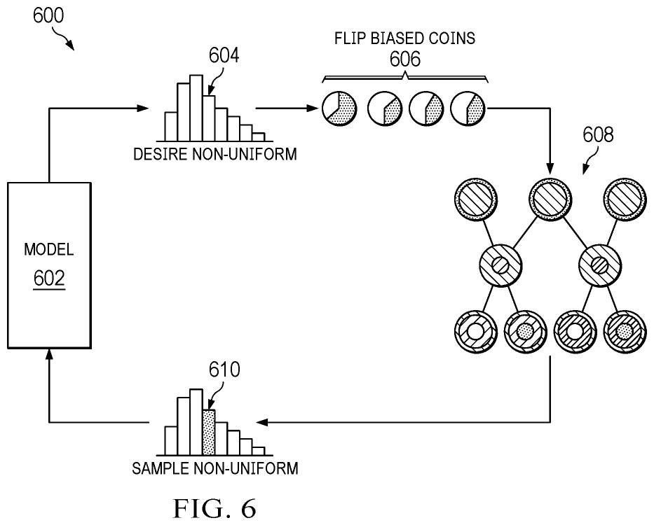

FIG. 6 depicts a diagram illustrating a process for drawing model-specific random numbers from hardware in accordance with an illustrative embodiment. In this schema, a model 602 queries a random number from a desired non-unform distribution 604 using a number of Bernoulli coin flips 606. The coin flips 606 are biased according to a number of probabilities and may be implemented in stochastic coinflip devices such as MTJs or TDs as shown in FIGS. 3-5. The coinflips may be organized into a binary tree 608 to generate the sample 610.

It is clear that N=2\hat{ }k independently tuned devices can be used to generate a sample X from whatever distribution specified. However, such exponential scaling is clearly not desirable. By taking advantage of correlations between devices, however, the illustrative embodiments greatly reduce this device cost. The number of tuned coinflip devices can be reduced to N<2\hat{ }k with keeping the k-time by compressing the binomial tree.

Correlation can be induced between two coinflip devices that output independent streams. This correlation can be accomplished by creating a new output that is a dependent random variable based on an independent input. Linear correlation can be zero between dependent random variables. Therefore, two dependent coinflip devices may exhibit zero (linear) correlation, but if there are two independent random variables, they will be uncorrelated. However, samples from two independent random variables may have a non-zero sample correlation which happens by chance.

Compression can be accomplished several ways. In one method, within any level of the binomial tree, only one coinflip device may be used if the probabilities within the level are the same (or close such that the differences in probabilities are below a specified threshold, though this introduces compression error). The amount of compression in this case depends on the distribution. This approach is particularly important for lower precision bits, whose probabilities will all tend to move towards 50% in smooth distributions. This method can be applied to branches are close to but not exactly the same probability, which yields more savings but at the expense of accuracy.

Another method of compressing the binomial tree comprises introducing correlations from a circuit or device physics (e.g., magnetic or thermal or electrical field interactions) so that the tuning of a coinflip device shifts based on other coinflip devices. These dependencies may be known apriori and the binomial tree built accordingly, which allows the reuse of the same coinflip device for several different probability values.

Another method to compress the binomial tree comprises dynamic on-the-fly re-tuning of dependencies between coinflips devices. In this approach a coinflip device is re-tuned based on the output of the coinflip device above it in the binomial tree. This process essentially walks down the binomial tree by re-tuning the coinflip devices, which can allow compression down to k coinflip devices if the tuning is accurate enough.

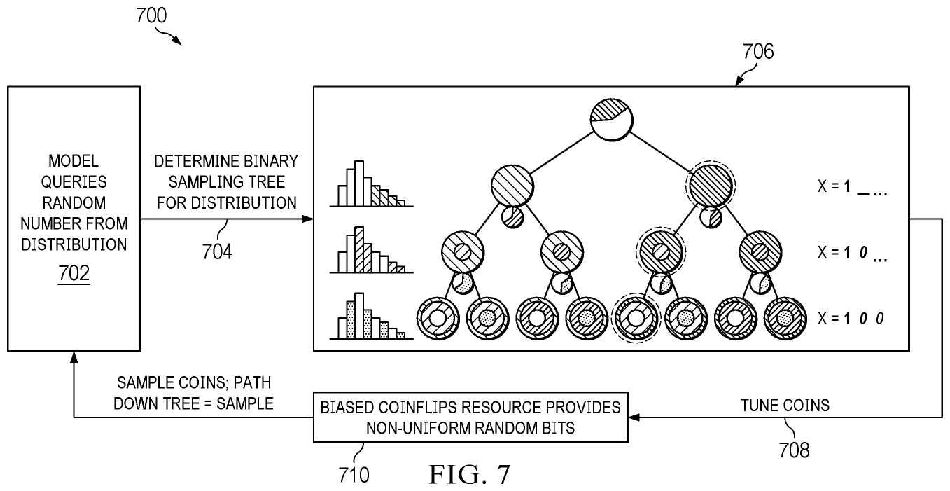

FIG. 7 depicts a diagram illustrating a process of random sampling with stochastic coinflip devices in accordance with an illustrative embodiment. Process 700 is a specific example implementation of process 600 in FIG. 6. The model queries a random number from a desired distribution (step 702). The process determines the appropriate binary tree 706 with which to execute the coin flips for the desired distribution in question (step 704).

The coinflip devices are tuned (step 708). Building a tree begins discretizing the distribution. If the distribution is defined by a PMF, it is already discretized. In the case of a PDF, bins are selected and then integrated. In the case of a CDF, bins are selected and the endpoints subtracted. As a result, the distribution is discretized to N outcomes, each with a probability of occurring. The N outcomes are then numbered without loss of generality (WLOG), e.g., in binary. The N outcomes can be numbered in any order, left-to-right, right-to-left, greatest-to-least, etc. Once the N outcomes are numbered, a total sum of probabilities is calculated for those numbers that start with 0 in their binary numbering. This sum is the probability of tails for the first coin flip. In the next level of the tree, a sum of probabilities is calculated for those numbers that start with 00 in their binary numbering, and this sum is then divided by the sum total probability of the numbers starting with 0. The result of this division is the probability of tails for the first coin flip in the second level.

For the second coin flip in the second level, the probabilities of those numbers starting with 10 in their binary encoding are summed and the divided by the sum total probabilities of those numbers starting with 1 in their binary encoding, producing the probability of ails for the second coin flip in the second level of the tree. This process continues to the rest of the levels and coin flips in the tree.

The biased coinflips provide a number of random bits that are converted to a k-bit sample number from the desired distribution (step 710).

Importantly, a given coinflip device may be used multiple times in multiple ways. For example, the probability of getting X=111 may be P([111])=b0*b1*b2, whereas the probability of getting X=110 may be P([110])=b0*b1*(1−b2). These expansions can become complicated when correlations are considered or in the cases where different branches of a binomial tree have different probabilities (thus use different devices).

Ultimately, each element of X will be some function of multiplying certain combinations of the outputs. However, this expansion can also be considered as a weighted sum of device outputs (where devices now take “1” and “−1” and weights are “1” and “−1”). Through this perspective, each element of X is essentially a threshold gate, or compatible with neuromorphic architectures.

In principle, the algorithmic approach described above should work with the envisioned devices above assuming complete control over the tunability of the devices and the correlations between devices. However, in reality, only moderate control over the tunability of devices is likely. A more realistic option is to create a large number of randomly tuned devices. Likewise, by relying on physics to provide correlations, there is only limited control over those, particularly higher-level correlations. So likewise, it is better to consider that an architecture will have correlations between certain devices available if they are useful.

The illustrative embodiments provide a sheet of coinflip devices that each can provide a coinflip. The coinflip devices are physically laid out on some surface such as a grid configuration (see FIG. 3) (though, given the correlation considerations, alternative configurations are possible). Each coinflip device has some independently tuned probability for H->T and T->H. For simplicity the tuning can be random.

Given the algorithm above, for each desired distribution, there is some combination of Bernoulli probabilities for the various coinflip devices that can be used to approximate the binary-representation elements of X. A naïve architecture would be to simply have a coinflip device for each required Bernoulli coinflip in the algorithm that is specifically tuned for the required mapping. However, in this case it is not necessary to have a device pre-assigned to be b0, another device pre-assigned b1 and so forth, and there may be no ability to tune them carefully. However, the sheet of coinflips can be seen as a resource for what would amount to a “look up table” of coinflips.

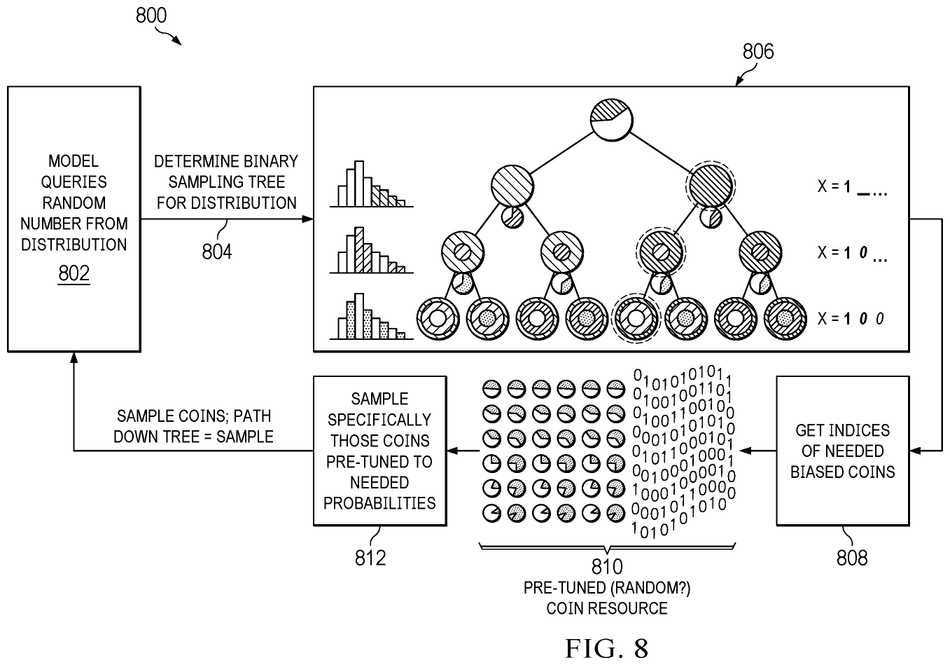

FIG. 8 depicts a diagram illustrating a process of random sampling with pre-tuned coinflip devices in accordance with an illustrative embodiment. Process 800 is an alternate example implementation of process 600 in FIG. 6. The model queries a random number from a desired distribution (step 802). The process determines the appropriate binary tree 806 with which to execute the coin flips for the desired distribution in question (step 804). The system then retrieves indices of needed bias coins (step 808).

In this embodiment, the coinflip devices 810 are pre-tuned and accessed according to the binary tree 806 (or compressed tree). The arrangement of the pre-tuned coinflip devices 810 is analogous to random access memory but is actually a random access number. The binary tree is in effect a program for how to access the array of coinflip devices 810, which may be performed in serial or parallel. The system specifically samples those coinflip devices that are pre-tuned to the needed probabilities (step 812).

For any random number mapping, the probabilities required for each Bernoulli element (b0, b1, b2, . . . ) are identified. Coinflip devices on the sheet are then identified that are the best fit for the desired Bernoulli elements. This process might be viewed as a discrete optimization problem of finding the set of available Bernoulli elements that provide the best overall approximation of the random number. If correlations are present on the hardware, spatial locations and correlations between coinflip devices may be factored into assignment of the coinflip devices to the Bernoulli elements. Timing of sampling an individual coinflip device can also be used to provide positive correlations (HH or TT) if the algorithm requires it.

The result of this procedure and use of the architecture is that each different random number mapping used a different set of coinflip devices in different ways. In effect, the set of coinflip devices used is the implementation of the algorithm on the architecture.

Considering, for example, an uncorrelated case with a 32×32 sheet of coinflip devices, the devices may be randomly distributed. In this case, there are 1024 random coinflips available to generate a desired sample. To generate, e.g., 3-bit random numbers from a distribution, out of the 1024 available coinflips, close probabilities be found, and the probabilities associated with the target random number are essentially what is needed.

The coinflip resource is only one part of the architecture. Because the algorithms can use any of the devices for any of the elements, there are many potential inputs to different compute elements. How that computation occurs depends on what correlations and elements may be used.

There are potentially a few techniques for accessing elements from the coinflips sheet. One technique is to think of it as a memory array, where the elements are simply “randomly accessed” according to some procedure. This approach takes advantage of effective memory technologies, and in a sense, views the coinflip operation as a “Random Numbers in Memory” analogue to “Processing in Memory.”

Alternatively, the coinflips sheet can be considered as a high-dimensional input to a population of neurons. Each neuron would essentially sample subsets of that random input according to the program (the synapses from the sheet to the neurons would represent the program). A neural-like architecture allows many-inputs to many-neurons as well as the required thresholding associated with the threshold gate-like coding. The neural network can map the N coin flips to an M-dimensional latent space that is then mapped to the k-bit random binary number.

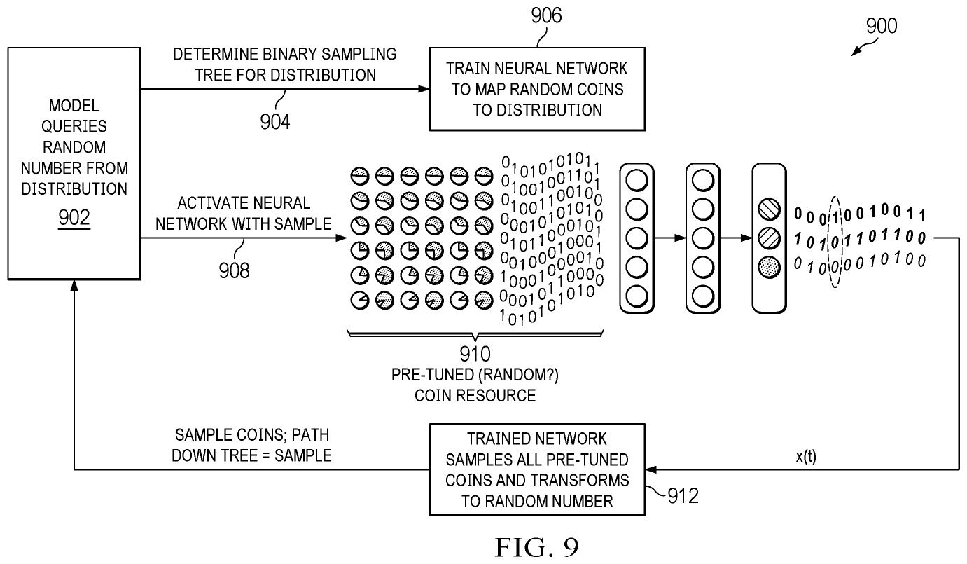

FIG. 9 depicts a diagram illustrating a process of random sampling with a neural network and pre-tuned coinflip devices in accordance with an illustrative embodiment. Process 900 is an alternate example implementation of process 600 in FIG. 6. The process determines the appropriate binary sampling tree for the desired distribution in question (step 904) and trains a neural network to map random coinflips to the desired distribution (step 906).

Similar to process 800 in FIG. 8, the arrangement of the pre-tuned coinflip devices 910 is analogous to random access memory but is actually a random access number. The binary sampling tree is in effect a program for how to access the coinflip devices 910, which can be done serially or in parallel. Sampling the desired distribution activates the neural network (step 908). The trained neural network then samples all pre-tuned coinflip devices 910 and transforms the random bits that are converted to a k-bit sample number from the desired distribution (step 912).

These two alternative uses of the coinflips sheet have a quite different surrounding systems and different types of I/O, but the underlying coinflips circuit is not that different. Importantly, which of these approaches is ideal depends on the type of application. If many random numbers will be generated from a particular distribution, such as in a Monte Carlo application, the neural framework (which essentially will program the neural interface to listen to certain devices) is likely more efficient. Alternatively, if the random numbers change over the course of an application, with potentially the need to sample from many different distributions in succession, the coinflips sheet as a memory is likely a more efficient approach. Stated differently, the memory use of the coinflips array has lower overhead but is less efficient per cycle. The neural approach is cheaper per random number generated but has higher overhead for each particular RN implementation.

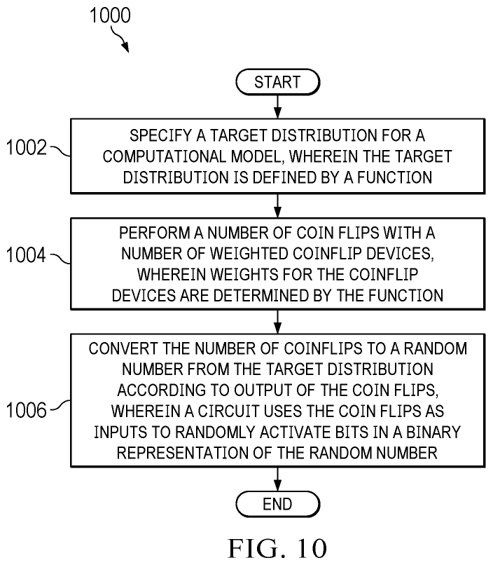

FIG. 10 depicts a flowchart illustrating a process for probabilistic computing in accordance with illustrative embodiments. Process 1000 might be implemented in tRNG 100 shown in FIG. 1.

Process 1000 begins by specifying a target distribution for a computational model, wherein the target distribution is defined by a function (step 1002). The function may be one of a probability density function, probability mass function, a cumulative distribution function, or a characteristic function.

A number of coin flips are performed with a number of weighted coinflip devices, wherein weights for the coinflip devices are determined by the function (step 1004). Each weighted coinflip device may represent a specific range within the target distribution. The weighted coinflip devices may be mapped to a latent space that is mapped to the function. Each weighted coinflip device may represent a Bernoulli probability. Each weighted coinflip device may be behave. as an n-sided die roll.

The weighted coin flip devices may comprise at least one of magnetic tunnel junction devices, tunnel diodes, or CMOS transistors. The weighted coinflip devices may be positioned at intersections of a crossbar array. The weighted coin flip devices operate in parallel.

Each weighted coinflip device may have an independently tuned probability. Alternatively, each weighted coinflip device may have a dependently tuned probability based on simultaneous or serial interaction with other weighted coinflip devices.

The number of coinflips are converted to a random number from the target distribution according to output of the coin flips, wherein a circuit with the coin flips as inputs randomly activates bits in a binary representation of the random number (step 1006). The random number may comprise a binomial expansion of the coin flips.

Process 1000 then ends.

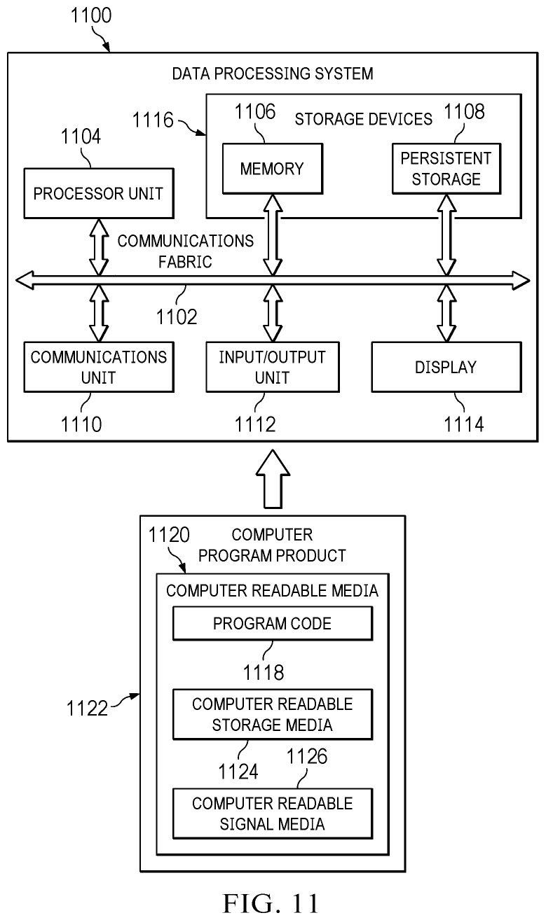

Turning now to FIG. 11, an illustration of a block diagram of a data processing system is depicted in accordance with an illustrative embodiment. Data processing system 1100 may be used to implement computer system 150 in FIG. 1. In this illustrative example, data processing system 1100 includes communications fabric 1102, which provides communications between processor unit 1104, memory 1106, persistent storage 1108, communications unit 1110, input/output unit 1112, and display 1114. In this example, communications fabric 1102 may take the form of a bus system.

Processor unit 1104 serves to execute instructions for software that may be loaded into memory 1106. Processor unit 1104 may be a number of processors, a multi-processor core, or some other type of processor, depending on the particular implementation. In an embodiment, processor unit 1104 comprises one or more conventional general-purpose central processing units (CPUs). In an alternate embodiment, processor unit 1104 comprises one or more graphical processing units (GPUs).

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108. Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications fabric 1102. The processes of the different embodiments may be performed by processor unit 1104 using computer-implemented instructions, which may be located in a memory, such as memory 1106.

These instructions are referred to as program code, computer-usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1118 may be transferred to data processing system 1100 using computer-readable signal media 1126. Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for probabilistic computing, the method comprising:
specifying a target distribution for a computational model, wherein the target distribution is defined by a function;
performing a number of coin flips with a number of weighted coinflip devices, wherein weights for the coinflip devices are determined by the function; and
converting the number of coinflips to a random number from the target distribution according to outputs of the weighted coinflip devices, wherein a circuit uses the coin flips as inputs to randomly activate bits in a binary representation of the random number.

2. The method of claim 1, wherein the function is one of:
a probability density function;
a probability mass function;
a cumulative distribution function; or
a characteristic function.

3. The method of claim 1, wherein the weighted coin flip devices comprise at least one of:
magnetic tunnel junction devices;
tunnel diodes; or
CMOS transistors.

4. The method of claim 1, wherein each weighted coinflip device has an independently tuned probability.

5. The method of claim 1, wherein each weighted coinflip device has a dependently tuned probability based on simultaneous or serial interaction with other weighted coinflip devices.

6. The method of claim 1, wherein each weighted coinflip device represents a specific range within the target distribution.

7. The method of claim 1, wherein the weighted coinflip devices are mapped to a latent space that is mapped to the function.

8. The method of claim 7, wherein the weighted coinflip devices are mapped to the latent space by a neural network.

9. The method of claim 1, wherein each weighted coinflip device represents a Bernoulli probability.

10. The method of claim 9, wherein each weighted coinflip device behaves as an n-sided die roll.

11. The method of claim 1, wherein the random number comprises an expansion of the coin flips in a binomial tree.

12. The method of claim 11, wherein the binomial tree is compressed by using only one coinflip device for a level of the binomial tree if probabilities within the level are the same or have differences below a specified threshold.

13. The method of claim 11, wherein the binomial tree is compressed by introducing correlations from a circuit or device physics such that a coinflip device tuning shifts based on other coinflip devices.

14. The method of claim 11, wherein the binomial tree is compressed by retuning dependencies between the coinflip devices on-the-fly, wherein a coinflip device is re-tuned based on the output of the coinflip device above it in the binomial tree.

15. The method of claim 1, wherein the weighted coinflip devices are positioned at intersections of a crossbar array.

16. The method of claim 1, wherein the weighted coinflip devices operate in parallel.

17. The method of claim 1, wherein the weighted coinflip devices operate serially.

18. A system for probabilistic computing, the system comprising:
a storage device that stores program instructions; and
one or more processors operably connected to the storage device and configured to execute the program instructions to cause the system to:
specify a target distribution for a computational model, wherein the target distribution is defined by a function;
perform a number of coin flips with a number of weighted coinflip devices, wherein weights for the coinflip devices are determined by the function; and
convert the number of coinflips to a random number from the target distribution according to outputs of the weighted coinflip devices, wherein a circuit uses the coin flips as inputs to randomly activate bits in a binary representation of the random number.

19. The system of claim 18, wherein the weighted coin flip devices comprise at least one of:
magnetic tunnel junction devices;
tunnel diodes; or
CMOS transistors.

20. A computer program product for probabilistic computing, the computer program product comprising:
a computer-readable storage medium having program instructions embodied thereon to perform the steps of:
specifying a target distribution for a computational model, wherein the target distribution is defined by a function;
performing a number of coin flips with a number of weighted coinflip devices, wherein weights for the coinflip devices are determined by the function; and
converting the number of coinflips to a random number from the target distribution according to outputs of the weighted coinflip devices, wherein a circuit uses the coin flips as inputs to randomly activate bits in a binary representation of the random number.
